(19) United States
(12) Patent Application Publication
(10) Pub. No.: US 2019/0284841 A1
(43) Pub. Date: Sep. 19, 2019

(54) TAG

(71) Applicant: MAINETTI (UK) LTD, Jedburgh, Roxburghshire (GB)

(72) Inventors: Michael Edward JONES, Ruthin (GB); Matthew Kendal HARDING, Warrington (GB)

(73) Assignee: Mainetti (UK) Ltd, Jedburgh, Roxburghshire (GB)

(21) Appl. No.: 16/317,595

(22) PCT Filed: Jul. 14, 2017
(86) PCT No.: PCT/GB2017/052087

§ 371 Date: Jan. 14, 2019

(30) Foreign Application Priority Data
Jul. 14, 2016 (GB) 1612266.5

(51) Int. Cl. E05B 73/00

(52) U.S. Cl. CPC E05B 73/0017; E05B 73/0052

(57) ABSTRACT

A tag for attaching to an item such as a bag containing goods is disclosed. The tag has two body portions each of which have a gripping portion for gripping the bag. The body portions are adapted to move the gripping portions towards and away from each other between a gripping condition for gripping the bag without piercing it and an open condition in which the bag can be inserted into and removed from the tag. There is also a locking device in the form of a pin and magnetic clutch which allows the tag to lock in the closed position and then be released by a magnetic release device.

The present invention relates to a tag and relates particularly, but not exclusively, to a tag used on a bagged item which is bought online from a retailer but collected from one of that retailer's stores.

It is increasingly common for retailers who have physical stores or shops to sell goods online and for a delivery option to be offered of picking these goods up from the retailer's store. It is also commonplace, particularly where the goods bought are garments, for those goods to be transported to the store and given to the customer in a sealed bag or similar packaging. These sealed bags, known as Internet bags, need to be identified and tracked by the retailers tracking systems as they pass from warehouse to distribution and onto the store. Labels stuck to these bags with readable codes can be used but such labels are not always readable. Disposable self-adhesive RFID tags can be used on the Internet bags but these increase the cost of packaging used. A further alternative is to use a standard security tag that is linked to a stores alarm system. However, the pins used in the security tags must pierce the item they are attached to and this can result in damage to the garment or other item inside the bag. When such security tags are used in stores and attached to the garment the tag is strategically placed where it will not result in damage to the garment. When a garment is placed in an opaque Internet bag, there is a danger that the garment will be pierced and this piercing/damage will be on an important and/or visible part of the garment. Furthermore, piercing the sealed back risks allowing contaminants such as water into the bag thereby further risking damage to the bag contents.

Preferred embodiments of the present invention seek to overcome or alleviate the above described disadvantages of the prior art.

According to an aspect of the present invention there is provided a tag for attaching to an item, the tag comprising:—

first and second body portions having respective first and second gripping portions, said first and second body portions adapted to move said first and second gripping portions towards and away from each other between a gripping condition for gripping an item the tag is attached to without piercing said item and an open condition in which said tag can be placed into engagement with said item or removed therefrom; and
a locking device for locking said body portions in said gripping condition and for releasing from said locking condition.

By providing a non-piercing tag with gripping portions to grip to an item, such as an Internet bag, and a locking device to ensure that the gripping portions remain in a gripping condition, provides significant advantages over the prior art. For example, such a tag is very easy to attach to packaging such as an Internet bag and ensures that the functions of that tag, for example identification of the item, are consistently available, for example, consistently on view, ensuring efficient distribution and tracking of the item. Furthermore, the non-piercing nature of the tag will ensure that the tag does not damage the item contained therein. It is also the case that, because the first and second body portions simply move towards and away from each other between the opening gripping positions the tag can only be attached to an edge of the packaging thereby further reducing the risk of damage to the item inside.

In a preferred embodiment the locking device allows movement of said gripping portions towards said gripping condition and prevents movement towards said open condition without activating a release mechanism on said locking device.

By the locking device locking the body portions as they move towards the gripping condition and only releasing with the intervention of something to activate the release mechanism the advantage is provided that the tag can be easily added to an item. In particular, this allows the tag in the open condition, to be quickly placed over the packaging and squeezed shut into the locking condition. As a result, no external mechanism is required in order to lock the tag onto the item.

Magnetic tag release mechanisms are commonly used by retailers and therefore by including a magnet in the locking device the advantage is provided that existing tag release mechanisms can be used to remove the tag.

In a further preferred embodiment the release mechanism comprises at least one magnetic clutch and at least one elongate member extending into said magnetic clutch, said magnetic clutch allowing said elongate member to move into engagement with said clutch but preventing said elongate member from being removed from engagement with said clutch without releasing said clutch using a magnetic release device.

The magnetic clutch release mechanism is the standard used by retailers for releasing security tags used on garments sold within the retailer's stores. As a result, using the same mechanisms provides the advantage that these low-cost items can be used in the tag of the present invention as part of the locking mechanism whilst not using their normal function of piercing the garment. The cost of this tag can be similar to that of existing tags. Retailers do not need to add any additional apparatus to their stores in order to operate this different form of tag and the tag operates in a manner that is familiar to the retailer's staff and they therefore do not need significant training to use the tag. This in turns leads to greater use and acceptance of the tag.

In a still further preferred embodiment the elongate member comprises a pin.

By using a pin as the elongate member the advantage is provided that these devices are commonly sold alongside the magnetic clutch meaning that these standard low-cost items can be incorporated in the device of the present invention. This is achieved whilst not using the pin for its primary function, that is piercing, and only using the magnetic clutch and pin as the locking mechanism within this non-piercing tag.

The tag may further comprise identification means and the identification means may comprise a visible device readable code and/or a radio frequency identification device.

The use of identification means, and in particular a QR code or RFID, provides the advantage that the tag can be used for tracking the item it is attached to through a retailers distribution system to a store.

The tag may further comprise security means and the security means may comprise a radio frequency identification device and/or an acousto-magnetic device.

The use of security means, and in particular an RFID or AM device, provides the advantage that the tag will set off and alarm if the tag is still attached to the packaging of an item as a customer leaves the store. Because the items have already been purchased they are not on display in stores and therefore the risk of theft or shoplifting of these items is limited. However, the use of the security means is to prevent the tag from being left on the item when it is collected by the customer. Although the tags are not expensive they are of no use to the customer and it is therefore preferable that the retailer retains the tags for reuse.

In a preferred embodiment the first and second body portions slide towards and away from each other between said gripping and open conditions.

The tag may further comprise biasing means urging said first and second body portions towards said open condition.

In another preferred embodiment the first and second gripping portions respectively comprise protrusions and recesses.

In a further preferred embodiment at least one of said first and second gripping portions comprise a rubberised material.

Preferred embodiments of the present invention will now be described, by way of example only, and not in any limitative sense with reference to the accompanying drawings in which:—

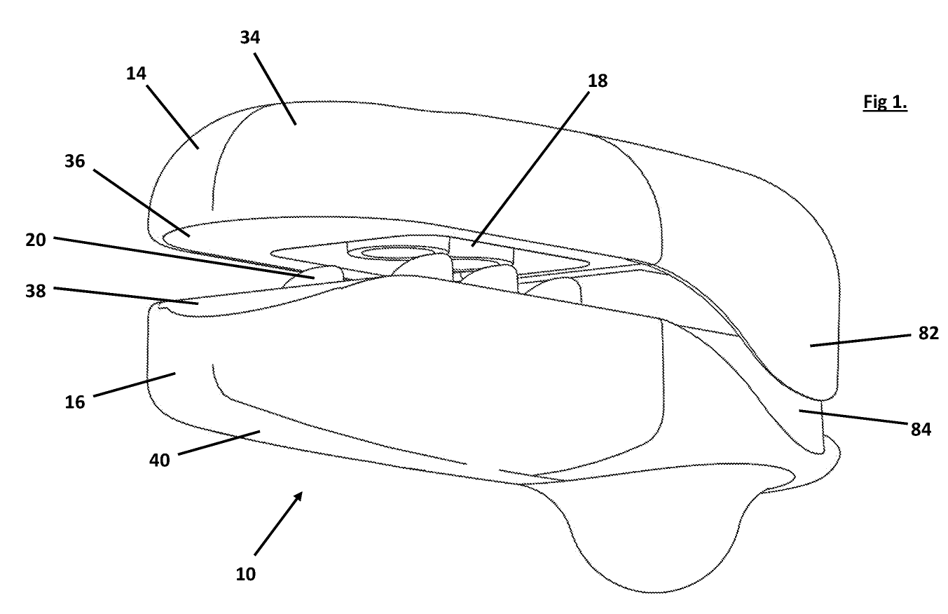

FIG. 1 is a perspective view of a tag of the present invention;

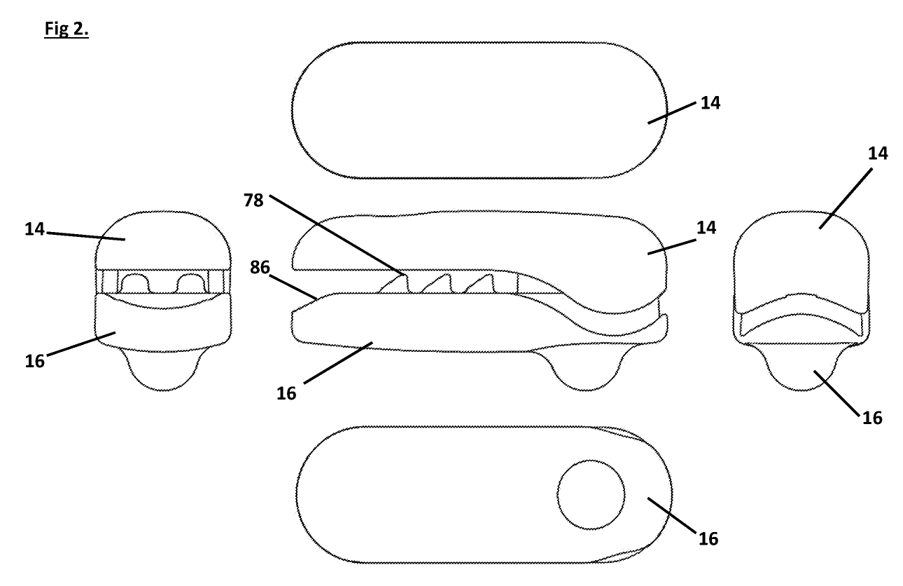

FIG. 2 is an orthographic projection view of the tag of FIG. 1 including front, rear, plan, side and bottom views;

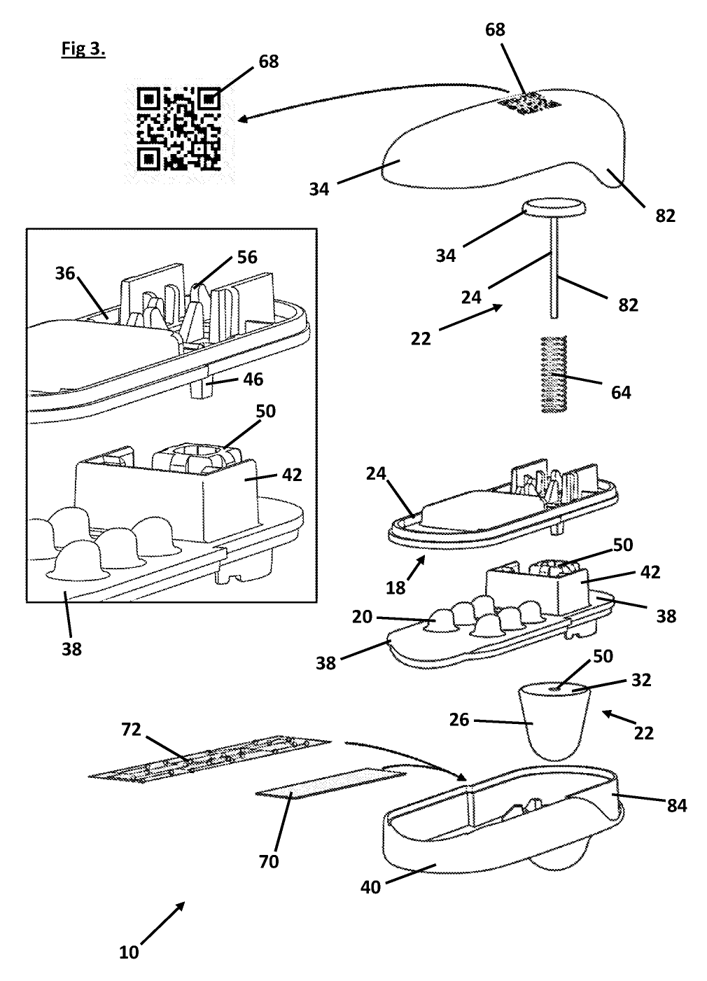

FIG. 3 is a perspective exploded view from above, including an enlarged portion, of the tag of FIG. 1;

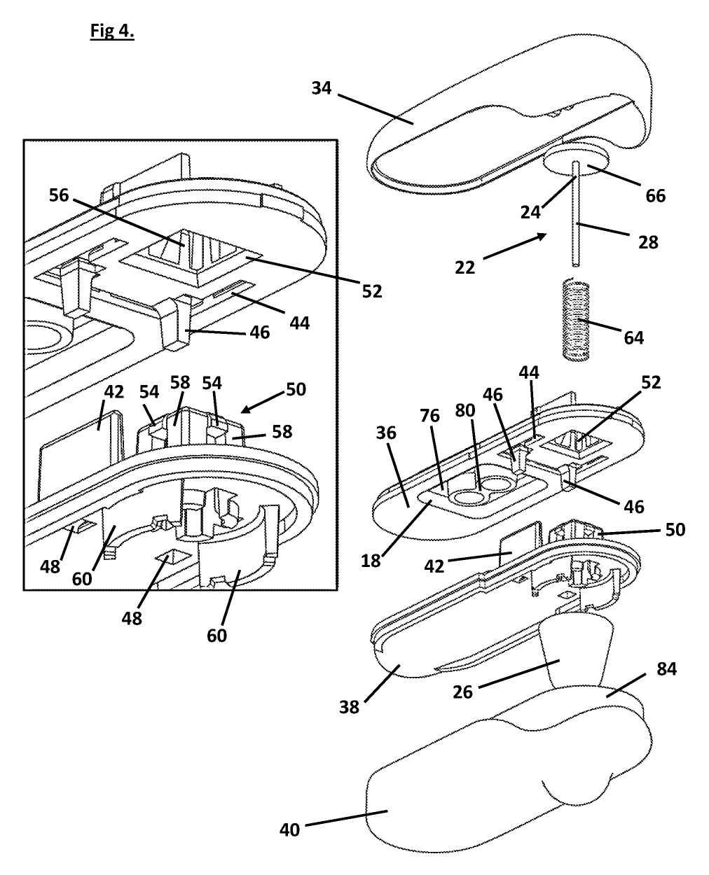

FIG. 4 is another perspective exploded view, including an enlarged portion, of the tag of FIG. 1 but from below; and

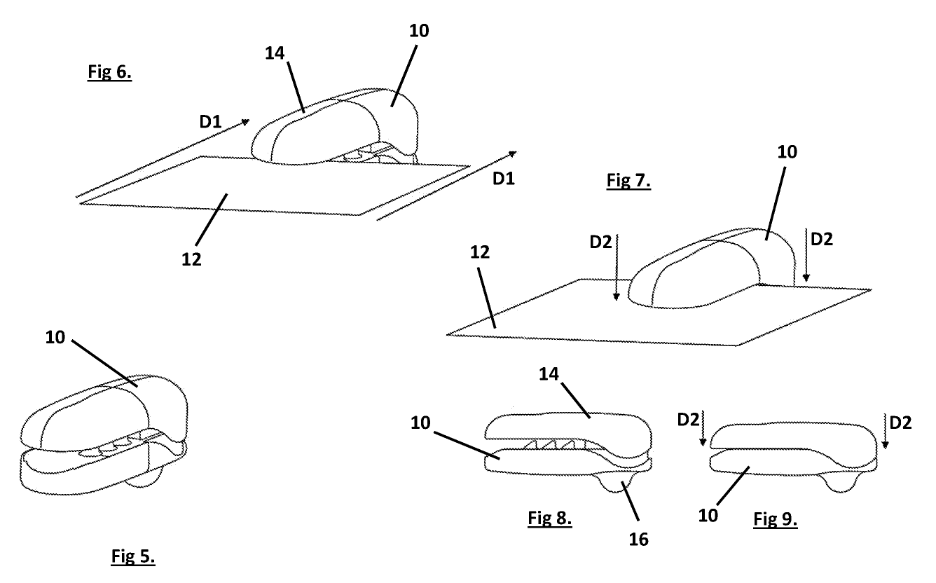

FIGS. 5 to 14 are perspective views demonstrating the operation of the tag of FIG. 1.

Referring to the figures, a tag 10 is used for attaching to an item such as a bag 12. This bag 12 is typically a sealed bag containing an item, such as a clothing garment, which has been bought online and is to be collected from the retailer's store or shop. Such bags are referred to as Internet bags. However, the item to which the tag 10 is attached could be anything that the tag can successfully attached to and which would generally include a flexible portion including but not limited to garments, garment labels and other items formed with labels of fabric and the like. The external surfaces of the tag 10 are defined by a first body portion 14 and a second body portion 16. The body portions 14 and 16 have respective gripping portions, these being first gripping portion 18 and second gripping portion 20. The first gripping portion 18 is in the form of a recess into which extends the second gripping portion 20, in the form of a series of protrusions. The first and second body portions 14 and 16 are formed separately, see further explanation below, but together form a single integral unit including both body portions and which in normal use are not separable.

The first and second body portions 14 and 16 are able to slide relative to each other such that the first and second gripping portions 18 and 20 move between an open condition and a gripping condition. The movement from open condition to gripping condition is shown in FIGS. 8 and 9 and the reverse movement is shown in FIGS. 11 and 12. When the first and second gripping portions 18 and 20 are further apart, as shown in FIGS. 8 and 12, the tag 10 is in an open condition. When the first and second gripping portions 18 and 20 are closer together, as shown in FIGS. 9 and 11, the tag 10 is in a gripping condition. The precise separation of the first and second gripping portions 18 and 20 in the gripping condition is determined by the item 12 which they are gripping. A thicker or less flexible item will result in the first and second gripping portions being slightly more separated than a thinner or more flexible item. The purpose of the gripping condition is to ensure that the tag 10 remains connected to the item 12 without piercing the bag as the pin of a standard security tag of the prior art would do.

Referring to the exploded views in FIGS. 3 and 4, the tag 10 includes a locking device (generally indicated at 22) which is formed from a pin 24 and a magnetic clutch 26. This pin 24 and magnetic clutch 26 are of a type commonly used in security tags. The elongate member or shaft 28 of pin 24 extends into an aperture 30 in end surface 32 of magnetic clutch 26. These magnetic clutches 26 are readily available and their workings will be familiar to person skilled in the art. Detailed descriptions of the mechanism within the clutch 26 will not be given beyond saying that a typical example works by having a spring mechanism pushing a plurality of ball bearings into engagement with the shaft 28 of pin 24 as it extends into the clutch 26. Any attempt to pull the pin 24 out of the clutch 26 results in the ball bearings pressing into closer engagement with the shaft 28 thereby preventing movement of the pin 24. By application of an external magnet in the correct position the ball bearings are released from engagement with the shaft 28 thereby allowing free movement of the pin 24 and therefore its removal from the clutch 26. Alternative variations of this clutch mechanism can also be used in the present invention.

The first body portion 14 is formed from a first housing portion 34 and a second housing portion 36 whilst the second body portion is formed from a third housing portion 38 and a fourth housing portion 40. The first and fourth housing portions 34 and 40 form the outermost casing of the tag 10 whilst the second and third housing portions 36 and 38 include the first and second gripping portions 18 and 20. The mechanism which allows and limits the sliding motion of the first and second body portions 14 and 16 towards and away from each other are also formed in the second and third housing portions 36 and 38. This mechanism includes a U-shaped wall 42 which extends from the third housing portion 38 and into a U-shaped aperture 44 in the second housing portion 36. A pair of legs 46 extend from the second housing portion 36 into a pair of apertures 48 which are located within the boundaries of the wall 42. The purpose of the U-shaped wall 42 and respective aperture 44 and the pair of legs 46 with their respective apertures 48 is to assist in ensuring the linear movement of the first and second body portions 14 and 16 relative to each other and to prevent the body portions from being able to pivot as this leads to the separation of the first and second gripping portions 18 and 20 and can allow the item 12 to be unintentionally removed from the secure grasp of the tag 10.

Also included in the mechanism, which allows and limits the sliding motion of the first and second body portions 14 and 16, is a box portion 50 and a respective aperture 52. The box portion 50 has four sides and the aperture 52 is square. Each of the four sides of box portion 50 has a cam tooth 54 and the distance between the outer edges of the cam teeth 54 on opposing sides of the box portion 50 is slightly greater than the distance between opposing edges of the square aperture 52. As a result, once the box portion 50 has been pushed into the square aperture 52 the cam teeth 54 prevent the box portion 50 from entirely passing back through the square aperture 52 thereby keeping the second and third housing portions 36 and 38, and therefore the first and second body portions 14 and 16, in permanent engagement with each other. Surrounding the square aperture 52 on the inside of the first body portion 14 are eight buttresses 56 which are arranged in pairs with two buttresses on each edge of square aperture 52. The buttresses 56 are spaced apart and engage sidewalls 58 of the box portion 50 on either side of the cam teeth 54.

On the inside of the second body portion 16 a pair of small walls 60, formed in the third housing portion 38, and further buttresses 62, formed in the fourth housing portion 40, support and position the magnetic clutch 26. Also forming part of the tag 10 is biasing means, in the form of spring 64 which extends from a head 66 of pin 24, through the second housing portion 36, through the box portion 50 and engages at its other end the end surface 32 of magnetic clutch 26. This spring 64 urges the first and second body portions away from each other and therefore the first and second gripping portions 18 and 20 towards the open condition.

Further components of tag 10 are, individually or in optional combinations, identification means in the form of a QR code 68, security means in the form of an acousto-magnetic (AM) tag 70 and a radio frequency identification tag (RFID) 72 which can fulfil either or both of the identification and security functions. The QR code 68 is shown printed on the first housing portion 34 and the AM and RFID tags 70 and 72 are shown insert it into the second body portion 16. However, these locations are arbitrary and can be changed as required or as is most convenient.

In this embodiment of the invention the second gripping member 20 is shown as a series of six protrusions 74 which extend into a recess 76. The protrusions 74 are tooth shaped with the point 78 of the protrusion 74 pointing towards the U-shaped wall 42. The recess 76 has a further protrusion 80 which has a figure-of-eight shape which creates within the recess 76 six sub recesses into which the tooth shaped protrusions 74 extend when the first and second gripping portions 18 and 20 are brought together.

Referring again to the first housing portion 34, an extension wall 82, formed as part of the first housing portion 34, extends below the second housing portion 36 and into a matching recess 84 formed in the fourth housing portion 40. The extension wall 82 and the U-shaped wall 42 ensure that the connection between the first and second body portions 14 and 16 remains hidden when the tag 10 is in the open condition. The front edge of the second body portion 16, that is the edge furthest away from the box portion 50, is angled away from the first body portion 14 so as to create a larger opening to the tag 10 so as to allow the item 12 easier entry into the space between the first and second body portions 14 and 16.

Operation of the tag 10 will now be described with reference to FIGS. 5 to 14. FIG. 5 shows the tag 10 in an open condition ready for use. As shown in FIG. 6, the item 12 is introduced into the gap between the first and second body portions 14 and 16 by moving it in the direction D1. The U-Shaped wall 42 acts to limit the movement of the item 12 in direction D1.

As shown in FIG. 7, the first and second body portions 14 and 16 are then brought together, effectively moving the first body portion 16 in the direction D2 against the biasing force of the spring 64. This movement from the open condition to the gripping condition is shown again, without the item 12 to be gripped, in FIGS. 8 and 9. As the first and second body portions 14 and 16 move towards each other the shaft 28 of pin 24 extends further into the magnetic clutch 26 through the aperture 30. Using the mechanism of the magnetic clutch 26, which is familiar to person skilled in the art, the ball bearings or similar contained therein, allow free movement of the shaft 28 further into the magnetic clutch 26, that is in direction D2, but prevent movement in the opposite direction. As a result, any movement of the first and second body portions 14 and 16 towards each other causes the first and second body portions to remain in that new position until the magnetic clutch is released. As the first and second body portions 14 and 16 move towards each other the protrusions 74 cause the flexible plastic material of the bag that is the item 12 to be deformed and pressed into the sub recesses of recess 76. As a result, the first and second gripping portions 18 and 20 apply a gripping force to the item 12.

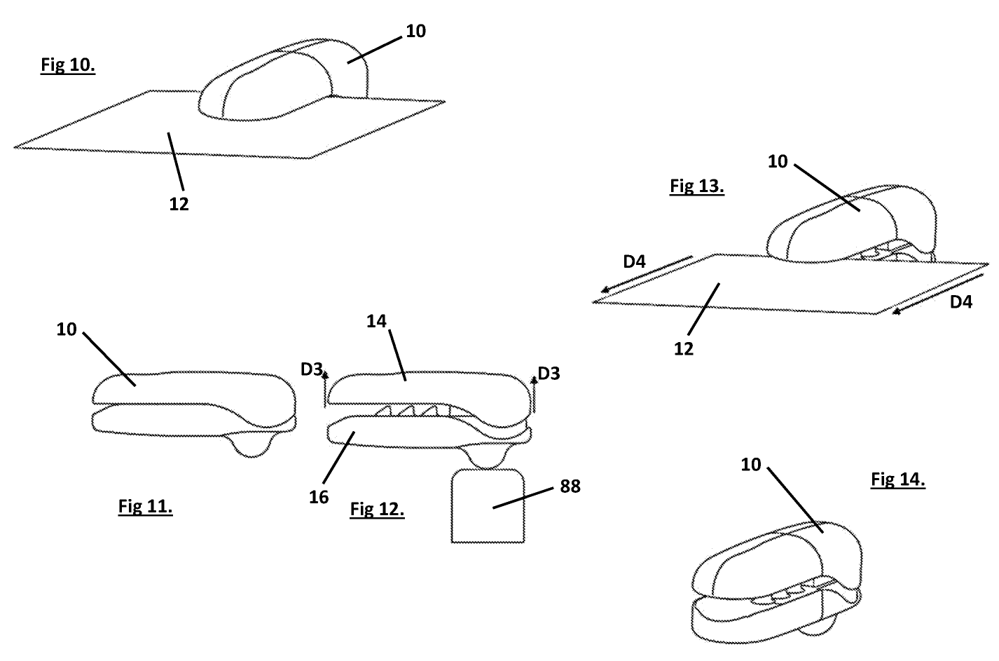

The tag 10 is thus in an attached condition to the item 12 and is then typically distributed to a retailer's store to be picked up by a customer. When the customer collects the item from the retailer's store the tag should be removed. This is achieved by moving the tag from the gripping condition, shown in FIG. 11 to the open condition shown in FIG. 12 and requires a magnetic release 88. To remove the item 12 the tag 10, and in particular the magnetic clutch 26 in the second body part 16, are brought into engagement with the magnetic release 88. As will be familiar to person skilled in the art this allows the ball bearings to disengage from the shaft 28 of pin 24 thereby allowing the pin 24 to move in direction D3 away from the magnetic clutch 26. With the magnetic release 88 unlocking the locking device 22 (pin 24 and magnetic clutch 26) the biasing force of the spring 64 acting against the end surface 32 of magnetic clutch 26 and the head 66 of pin 24 forces the first and second body portions away from each other which is shown in FIG. 12 as the first body portion 14 moving in direction D3. The cam teeth 54 catch on the edges of the square aperture 52 and prevent the second and third housing portions 36 and 38 and therefore the first and second body portions 14 and 16 from disengaging from each other. The shaft 28 of pin 24 remains extending slightly into the magnetic clutch 26 even when the tag 10 is in the open condition. Once in the open condition the item 12 can be moved in direction D4, as shown in FIG. 13, to remove it from engagement with the tag 10 which is then ready for reuse, as shown in FIG. 14.

It will be appreciated by persons skilled in the art that the above embodiments have been described by way of example only and not in any limitative sense, and that various alterations and modifications are possible without departure from the scope of the protection which is defined by the appended claims. For example, the protrusions 74 and recess 76 can be replaced with any other suitable gripping portions 18 and 20. Materials with a high coefficient of friction, such as rubberised materials, can be provided in the form of pads which are stuck to the second and third housing portions 36 and 38 and these can provide the required gripping force to maintain the tag 10 in engagement with the item 14.

1. A tag for attaching to an item, the tag comprising:—
first and second body portions having respective first and second gripping portions, said first and second body portions adapted to move said first and second gripping portions towards and away from each other between a gripping condition for gripping an item the tag is attached to without piercing said item and an open condition in which said tag can be placed into engagement with said item or removed therefrom; and
a locking device for locking said body portions in said gripping condition and for releasing from said locking condition.

2. A tag according to claim 1, wherein said locking device allows movement of said gripping portions towards said gripping condition and prevents movement towards said open condition without activating a release mechanism on said locking device.

3. A tag according to claim 1, wherein said release mechanism comprises at least one magnetic clutch and at least one elongate member extending into said magnetic clutch, said magnetic clutch allowing said elongate member to move into engagement with said clutch but preventing said elongate member from being removed from engagement with said clutch without releasing said clutch using a magnetic release device.

4. A tag according to claim 3, wherein said elongate member comprises a pin.

5. A tag according to claim 1, further comprising at least one identification device.

6. A tag according to claim 5, wherein said identification device comprises visible device readable code.

7. A tag according to claim 1, further comprising at least one security device.

8. A tag according to claim 7, wherein said security device comprises a radio frequency identification device.

9. A tag according to claim 7, wherein said security device comprises an acousto-magnetic device.

10. A tag according to claim 1, wherein said first and second body portions slide towards and away from each other between said gripping and open conditions.

11. A tag according to claim 1, further comprising at least one biasing means device urging said first and second body portions towards said open condition.

12. A tag according to claim 1, wherein said first and second gripping portions respectively comprise protrusions and recesses.

13. A tag according to claim 1, wherein at least one of said first and second gripping portions comprise a rubberised material.

14. (canceled)

15. A tag for attaching to an item, the tag comprising:
first and second body portions having respective first and second gripping portions, said first and second body portions adapted to slide relative to each other to move said first and second gripping portions towards and away from each other between a gripping condition for gripping an item the tag is attached to without piercing said item and an open condition in which said tag can be placed into engagement with said item or removed therefrom;
biasing means urging said first and second body portions towards said open condition; and
a locking device for locking said body portions in said gripping condition and for releasing therefrom, said locking device comprising at least one magnetic clutch and at least one pin member extending into said magnetic clutch, said magnetic clutch allowing said pin member to move into engagement with said clutch but preventing said pin member from being removed from engagement with said clutch without releasing said clutch using a magnetic release device, wherein said pin and clutch are contained within said first and second body portions with said pin attached to one of said first and second body portions and said clutch attached to the other of first and second body portions.
